(19) United States
(12) Patent Application Publication
(10) Pub. No.: US 2021/0194040 A1
(43) Pub. Date: Jun. 24, 2021

(54) LITHIUM-ION RECHARGEABLE BATTERY AND METHOD FOR MANUFACTURING LITHIUM-ION RECHARGEABLE BATTERY

(71) Applicant: SHOWA DENKO K.K., Tokyo (JP)

(72) Inventors: Takaki YASUDA, Ichihara-shi, Chiba (JP); Akira SAKAWAKI, Ichihara-shi, Chiba (JP); Tatsunori SHINO, Ichihara-shi, Chiba (JP)

(73) Assignee: SHOWA DENKO K.K., Tokyo (JP)

(21) Appl. No.: 16/498,606

(22) PCT Filed: Jan. 19, 2018
(86) PCT No.: PCT/JP2018/001569

§ 371 Date: Sep. 27, 2019

(30) Foreign Application Priority Data
Apr. 14, 2017 (JP) 2017-080642

(51) Int. Cl. H01M 10/0525; H01M 10/44; H01M 4/36; H01M 4/04; H01M 10/0562

(52) U.S. Cl. CPC H01M 10/0525; H01M 10/44; H01M 4/366; H01M 2004/027; H01M 10/0562; H01M 4/0423; H01M 4/0407

(57) ABSTRACT

A lithium-ion rechargeable battery 1 includes: a stainless-steel substrate 10; a negative electrode layer 20 that contains a negative-electrode active material and is laminated on the substrate 10; a solid electrolyte layer that contains an inorganic solid electrolyte having lithium-ion conductivity and is laminated on the negative electrode layer 20; a positive electrode layer 40 that contains a positive-electrode active material and is laminated on the solid electrolyte layer 30; and a positive electrode collector layer 50 that is composed of titanium and is laminated on the positive electrode layer 40. The boundary portion of the solid electrolyte layer 30 and the positive electrode layer 40 in the lithium-ion rechargeable battery 1 is provided with a mixture layer 70 in which the positive-electrode active material and the inorganic solid electrolyte are mixed. These increase the discharge capacity of the all-solid lithium-ion rechargeable battery.

### TECHNICAL FIELD

The present invention relates to a lithium-ion rechargeable battery and a method for manufacturing the lithium-ion rechargeable battery.

### BACKGROUND ART

With the popularization of the mobile electronic devices, such as the mobile phones or the laptop computers, development of a compact and lightweight rechargeable battery having high energy density is strongly desired. As a rechargeable battery satisfying such requirements, a lithium-ion rechargeable battery is known. The lithium-ion rechargeable battery includes a positive electrode containing a positive-electrode active material, a negative electrode containing a negative-electrode active material, and an electrolyte having lithium-ion conductivity and interposed between the positive electrode and the negative electrode.

In the conventional lithium-ion rechargeable battery, an organic electrolytic solution or the like was used as the electrolyte. In contrast thereto, an all-solid-state and thin-film-type lithium-ion rechargeable battery, which uses a solid electrolyte composed of an inorganic material (inorganic solid electrolyte) as the electrolyte and configures all of the negative electrode, the solid electrolyte and the positive electrode with thin films, has been suggested (refer to Patent Document 1).

### CITATION LIST

### Patent Literature

Patent Document 1: Japanese Patent Application Laid-Open Publication No. 2013-73846

### SUMMARY OF INVENTION

### Technical Problem

Here, the lithium-ion rechargeable battery is strongly desired to reduce an internal resistance as much as possible, and to increase battery capacity capable of being provided to the outside per a single charge. However, in the all-solid lithium-ion rechargeable battery without using an electrolytic solution, a region having a low degree of lithium ion conductivity was generated on an interface between the solid electrolyte and the positive electrode, and the discharge capacity of the battery became lower than the battery using the electrolytic solution in some cases. An object of the present invention is to increase a discharge capacity of an all-solid lithium-ion rechargeable battery.

### Solution to Problem

A lithium-ion rechargeable battery according to the present invention includes: a positive electrode layer containing a positive-electrode active material; a negative electrode layer containing a negative-electrode active material; a solid electrolyte layer containing an inorganic solid electrolyte having lithium-ion conductivity, the solid electrolyte layer being provided between the positive electrode layer and the negative electrode layer; and a mixture layer containing a mixture of the positive-electrode active material and the inorganic solid electrolyte, the mixture layer being provided between the positive electrode layer and the solid electrolyte layer.

In such a lithium-ion rechargeable battery, the positive-electrode active material contains an element heavier than an element contained in the inorganic solid electrolyte.

Moreover, in the mixture layer, particles composed of the positive-electrode active material are dispersed into a base material composed of the inorganic solid electrolyte.

Further, a boundary portion of the positive electrode layer and the mixture layer is provided with an intermediate layer containing a constituent material of the positive-electrode active material and a constituent material of the inorganic solid electrolyte, and further containing the positive-electrode active material mixed therewith.

Then, a substrate is further provided, on which the negative electrode layer, the intermediate layer and the positive electrode layer are laminated in this order.

Moreover, from another standpoint, a method for manufacturing a lithium-ion rechargeable battery according to the present invention includes: a negative electrode layer formation process that forms a negative electrode layer containing a negative-electrode active material; a solid electrolyte layer formation process that forms a solid electrolyte layer on the negative electrode layer, the solid electrolyte layer containing an inorganic solid electrolyte having lithium-ion conductivity; and a positive electrode layer formation process that forms, on the solid electrolyte layer, a mixture layer containing a mixture of a positive-electrode active material and the inorganic solid electrolyte, and forms, on the mixture layer, a positive electrode layer containing the positive-electrode active material.

In such a method for manufacturing a lithium-ion rechargeable battery, in the positive electrode layer formation process, the mixture layer and the positive electrode layer are formed by a sputtering method, and the positive-electrode active material contains an element heavier than an element contained in the inorganic solid electrolyte.

Moreover, in the positive electrode layer formation process, on the mixture layer, an intermediate layer containing a constituent material of the positive-electrode active material and a constituent material of the inorganic solid electrolyte, and further containing the positive-electrode active material mixed therewith is further formed.

### Advantageous Effects of Invention

According to the present invention, it is possible to increase the discharge capacity of the all-solid lithium-ion rechargeable battery as compared to a case in which the positive electrode layer and the solid electrolyte layer are brought into direct contact.

### BRIEF DESCRIPTION OF DRAWINGS

FIG. 1 is a diagram showing a cross-sectional configuration of a lithium-ion rechargeable battery to which an exemplary embodiment is applied;

FIG. 2 is a diagram viewing the lithium-ion rechargeable battery to which the exemplary embodiment is applied from above;

FIG. 3 is a flowchart for illustrating a method for producing the lithium-ion rechargeable battery;

FIG. 4 is a diagram showing a cross-sectional configuration of a lithium-ion rechargeable battery in Comparative Example;

FIGS. 5A and 5B are cross-sectional STEM photographs of a lithium-ion rechargeable battery in Example;

FIG. 6 is a cross-sectional STEM photograph of a lithium-ion rechargeable battery in Comparative Example; and

FIGS. 7A and 7B are diagrams showing charge-discharge characteristics of the lithium-ion rechargeable battery in Example and charge-discharge characteristics of the lithium-ion rechargeable battery in Comparative Example, respectively.

### DESCRIPTION OF EMBODIMENTS

Hereinafter, an exemplary embodiment according to the present invention will be described in detail with reference to attached drawings. Note that the size, thickness or the like of each component in the drawings referenced in the following description will differ from the actual dimension in some cases.

### [Configuration of Lithium-Ion Rechargeable Battery]

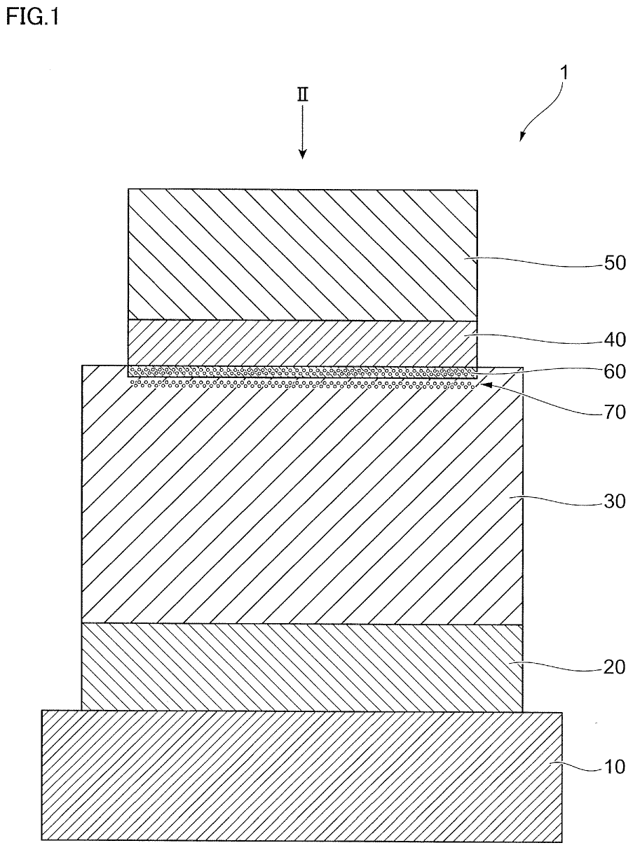

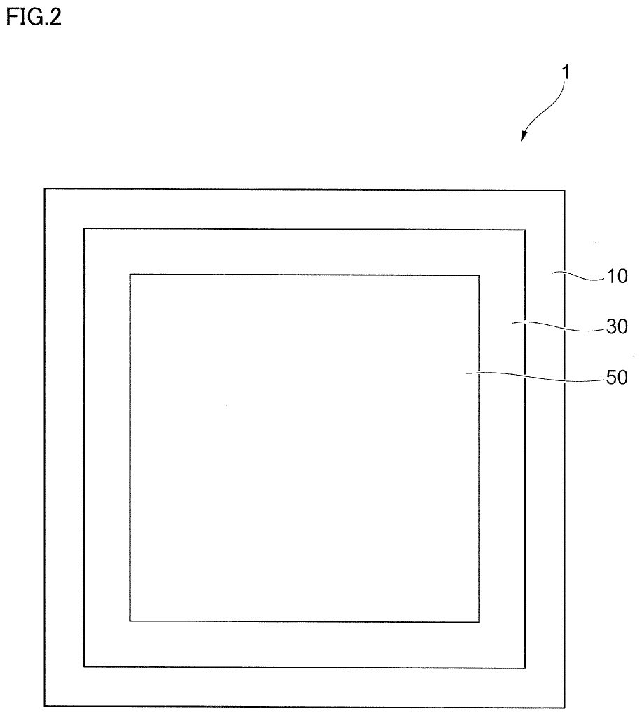

FIG. 1 is a diagram showing a cross-sectional configuration of a lithium-ion rechargeable battery 1 to which the exemplary embodiment is applied. Moreover, FIG. 2 is a diagram viewing the lithium-ion rechargeable battery 1 to which the exemplary embodiment is applied from above (from the direction II shown in FIG. 1).

The lithium-ion rechargeable battery 1 includes: a substrate 10; a negative electrode layer 20 laminated on the substrate 10; a solid electrolyte layer 30 laminated on the negative electrode layer 20; a positive electrode layer 40 laminated on the solid electrolyte layer 30; and a positive electrode collector layer 50 laminated on the positive electrode layer 40. Moreover, in the lithium-ion rechargeable battery 1, inside the solid electrolyte layer 30 at a boundary portion of the solid electrolyte layer 30 and the positive electrode layer 40, an intermediate layer exists, and, at a boundary portion of the solid electrolyte layer 30 and the intermediate layer 60, there exists a mixture layer 70.

In the exemplary embodiment, the substrate 10 has a square shape. Moreover, the negative electrode layer 20 and the solid electrolyte layer 30 laminated on the substrate 10 also have the square shape, and have the same size (area). However, one side of these negative electrode layer 20 and solid electrolyte layer 30 is shorter than one side of the substrate 10. The entire periphery of each of the negative electrode layer 20 and the solid electrolyte layer 30 is positioned inside the entire periphery of the substrate 10.

Further, the positive electrode layer 40 and the positive electrode collector layer 50 laminated on the solid electrolyte layer 30 also have the square shape, and have the same size (area). However, one side of these positive electrode layer 40 and positive electrode collector layer 50 is shorter than one side of the solid electrolyte layer 30. The entire periphery of each of the positive electrode layer 40 and the positive electrode collector layer 50 is positioned inside the entire periphery of the solid electrolyte layer 30.

Note that the intermediate layer 60 and the mixture layer 70 existing inside the solid electrolyte layer 30 also have the square shape, and have the same size (area). However, one side of these intermediate layer 60 and mixture layer 70 is substantially equal to one side of the positive electrode layer 40 (shorter than one side of the solid electrolyte layer 30). The entire periphery of each of the intermediate layer 60 and the mixture layer 70 is positioned inside the entire periphery of the solid electrolyte layer 30.

Next, each constituent of the lithium-ion rechargeable battery 1 will be described in more detail.

### (Substrate)

The substrate 10 is used for placing thereon a battery part that contains the negative electrode layer 20, the solid electrolyte layer 30, the positive electrode layer 40 and so forth. As the substrate 10, without particular limitation, those configured with various materials, such as metal, glass, ceramics and so on can be used.

In the exemplary embodiment, the substrate 10 is, for the purpose of serving as a negative electrode collector layer in the lithium-ion rechargeable battery 1, configured with a plate material made of metal having electron conductivity. To describe more specifically, in the exemplary embodiment, as the substrate 10, stainless steel foil (plate) having high mechanical strength as compared to copper, aluminum and the like is used. Moreover, as the substrate 10, metallic foil, which is obtained by plating with conductive metals, such as tin, copper, chrome and the like, may be used. Note that, when a material having insulation properties is used as the substrate 10, the negative electrode collector layer having electron conductivity may be provided between the substrate 10 and the negative electrode layer 20.

The thickness of the substrate 10 can be set at, for example, 20 μm or more and 200 μm or less. When the thickness of the substrate 10 is less than 20 μm, a pinhole or breaking is likely to occur in rolling in manufacturing the metallic foil or in heat sealing, and in addition, the electrical resistance value when being used as the negative electrode is increased. On the other hand, when the thickness of the substrate 10 exceeds 200 μm, a volume energy density and a weight energy density are reduced by increases in the thickness and the weight of the battery, and flexibility of the lithium-ion rechargeable battery 1 is deteriorated.

### (Negative Electrode Layer)

The negative electrode layer 20 is a solid thin film and contains a negative-electrode active material that occludes lithium ions in charging and releases lithium ions in discharging. Here, as the negative-electrode active material constituting the negative electrode layer 20, for example, carbon or silicon can be used. Moreover, the negative electrode layer 20 may be added with various kinds of dopants.

The thickness of the negative electrode layer 20 can be set at, for example, 10 nm or more and 40 μm or less. When the thickness of the negative electrode layer 20 is less than 10 nm, the capacity of the lithium-ion rechargeable battery 1 to be obtained becomes too small, and impractical. On the other hand, when the thickness of the negative electrode layer 20 exceeds 40 μm, it takes too much time to form the layer, and thereby, the productivity is deteriorated. However, when the battery capacity required of the lithium-ion rechargeable battery 1 is large, the thickness of the negative electrode layer 20 may exceed 40 μm.

Moreover, it does not matter whether the negative electrode layer 20 includes crystal structures or is in the amorphous state without including the crystal structures; however, in the point that expansion and contraction associated with occluding and releasing of lithium ions are more isotropic, it is preferable that the negative electrode layer 20 is in the amorphous state.

Further, as the manufacturing method of the negative electrode layer 20, known deposition methods, such as various kinds of PVD (physical vapor deposition) or various kinds of CVD (chemical vapor deposition), may be used; however, in terms of production efficiency, it is desirable to use a sputtering method (sputtering).

### (Solid Electrolyte Layer)

The solid electrolyte layer 30 is a solid thin film and contains a solid electrolyte made of an inorganic material (inorganic solid electrolyte). The inorganic solid electrolyte constituting the solid electrolyte layer 30 is not particularly limited as long as having lithium-ion conductivity, and those configured with various kinds of materials, such as oxides, nitrides or sulfides, may be used.

The thickness of the solid electrolyte layer 30 can be set at, for example, 10 nm or more and 10 μm or less. When the thickness of the solid electrolyte layer 30 is less than 10 nm, in the obtained lithium-ion rechargeable battery 1, a short circuit (leakage) between the positive electrode layer 40 and the negative electrode layer 20 is likely to occur. On the other hand, when the thickness of the solid electrolyte layer 30 exceeds 10 μm, the moving distance of lithium ion is elongated, and thereby, the charge and discharge rate is reduced.

Moreover, it does not matter whether the solid electrolyte layer 30 includes crystal structures or is in the amorphous state without including the crystal structures; however, in the point that expansion and contraction due to heat are more isotropic, it is preferable that the solid electrolyte layer 30 is in the amorphous state.

Further, as the manufacturing method of the solid electrolyte layer 30, known deposition methods, such as various kinds of PVD or various kinds of CVD, may be used; however, in terms of production efficiency, it is desirable to use the sputtering method.

### (Positive Electrode Layer)

The positive electrode layer 40 is a solid thin film and contains a positive-electrode active material that releases lithium ions in charging and occludes lithium ions in discharging. Here, as the positive-electrode active material constituting the positive electrode layer 40, for example, those configured with various kinds of materials, such as oxides, sulfides or phosphorus oxides containing at least one kind of metal selected from a group of manganese (Mn), cobalt (Co), nickel (Ni), iron (Fe), molybdenum (Mo) and vanadium (V), may be used. However, from a viewpoint of forming the intermediate layer 60 and the mixture layer 70 between the solid electrolyte layer 30 and the positive electrode layer 40 more securely, it is preferable that the positive-electrode active material in the positive electrode layer 40 contain elements heavier than those in the inorganic solid electrolyte in the solid electrolyte layer 30.

The thickness of the positive electrode layer 40 can be set at, for example, 10 nm or more and 40 μm or less. When the thickness of the positive electrode layer 40 is less than 10 nm, the capacity of the lithium-ion rechargeable battery 1 to be obtained becomes too small, and impractical. On the other hand, when the thickness of the positive electrode layer 40 exceeds 40 μm, it takes too much time to form the layer, and thereby, the productivity is deteriorated. However, when the battery capacity required of the lithium-ion rechargeable battery 1 is large, the thickness of the positive electrode layer 40 may exceed 40 μm.

Moreover, it does not matter whether the positive electrode layer 40 includes crystal structures or is in the amorphous state without including the crystal structures; however, in the point that expansion and contraction associated with occluding and releasing of lithium ions are more isotropic, it is preferable that the positive electrode layer 11 is in the amorphous state.

Further, as the producing method of the positive electrode layer 40, known deposition methods, such as various kinds of PVD or various kinds of CVD, may be used; however, in terms of production efficiency, it is desirable to use the sputtering method.

### (Positive Electrode Collector Layer)

The positive electrode collector layer 50 is not particularly limited as long as being a solid thin film having electron conductivity, and it is possible to use, for example, metals such as titanium (Ti), aluminum (Al), copper (Cu), platinum (Pt) or gold (Au), or conductive materials containing alloys of these metals.

The thickness of the positive electrode collector layer 50 can be set at, for example, 5 nm or more and 50 μm or less. When the thickness of the positive electrode collector layer 50 is less than 5 nm, the power collection function is deteriorated, to thereby become impractical. On the other hand, when the thickness of the positive electrode collector layer 50 exceeds 50 μm, it takes too much time to form the layer, and thereby, the productivity is deteriorated.

Moreover, as the manufacturing method of the positive electrode layer 50, known deposition methods, such as various kinds of PVD or various kinds of CVD, may be used; however, in terms of production efficiency, it is desirable to use the sputtering method or a vacuum deposition method.

### (Intermediate Layer)

The intermediate layer 60 is a solid thin film, and, in the boundary portion of the solid electrolyte layer 30 and the positive electrode layer 40, positioned closer to the solid electrolyte layer 30. The intermediate layer 60 contains constituent materials of the inorganic solid electrolyte in the solid electrolyte layer 30 and constituent materials of the positive-electrode active material in the positive electrode layer 40. For example, when the inorganic solid electrolyte of the solid electrolyte layer 30 is composed of LiPON (a compound of lithium, phosphorous, oxygen and nitrogen) and the positive-electrode active material of the positive electrode layer 40 is composed of LiMnO (a compound of lithium, manganese and oxygen), the intermediate layer 60 contains lithium, phosphorous, manganese, oxygen and nitrogen.

Moreover, in the intermediate layer 60, the positive-electrode active material constituting the positive electrode layer 40 does not form any compound with other materials, and maintains itself to be mixed. To describe more specifically, the intermediate layer 60 of the exemplary embodiment includes a structure in which fillers (particles) of the positive-electrode active material constituting the positive electrode layer 40 are dispersed into a matrix (a base material) composed of the constituent materials of the inorganic solid electrolyte in the solid electrolyte layer 30 and constituent materials of the positive-electrode active material in the positive electrode layer 40.

The thickness of the intermediate layer 60 can be set at, for example, 10 nm or more and 100 nm or less. When the thickness of the intermediate layer 60 is less than 10 nm, the internal resistance of the lithium-ion rechargeable battery 1 to be obtained becomes too high, and impractical. On the other hand, when the thickness of the intermediate layer 60 exceeds 100 nm, insulation resistance between the positive electrode and the negative electrode expected of the solid electrolyte layer 30 is reduced.

Moreover, it does not matter whether the intermediate layer 60 includes crystal structures or is in the amorphous state without including the crystal structures; however, in the point that expansion and contraction due to heat are more isotropic, it is preferable that the intermediate layer 60 is in the amorphous state.

Further, as the manufacturing method of the intermediate layer 60, the layer may be independently manufactured; however, from the viewpoint of production efficiency, it is desirable that the intermediate layer 60 be secondarily generated in the process of manufacturing the solid electrolyte layer 30 and the positive electrode layer 40.

### (Mixture Layer)

The mixture layer 70 is, as described above, positioned at the boundary portion of the solid electrolyte layer 30 and the intermediate layer 60. Then, in the mixture layer 70, the inorganic solid electrolyte constituting the solid electrolyte layer 30 and the positive-electrode active material constituting the positive electrode layer 40 are mixed while each of which maintains itself. To describe more specifically, in the mixture layer 70, one of them (for example, the inorganic solid electrolyte) serves as the matrix (the base material) and the other (for example, the positive-electrode active material) serves as the fillers (the particles). For example, when the inorganic solid electrolyte of the solid electrolyte layer 30 is composed of LiPON (a compound of lithium, phosphorous, oxygen and nitrogen) and the positive-electrode active material of the positive electrode layer 40 is composed of LiMnO (a compound of lithium, manganese and oxygen), the mixture layer 70 includes a region composed of LiPON and a region composed of LiMnO.

The thickness of the mixture layer 70 can be set at, for example, 10 nm or more and 200 nm or less. When the thickness of the mixture layer 70 is less than 10 nm, effects in reducing the interface resistance are decreased. On the other hand, when the thickness of the mixture layer 70 exceeds 200 nm, insulation resistance between the positive electrode and the negative electrode expected of the solid electrolyte layer 30 is reduced.

Moreover, it does not matter whether the mixture layer 70 includes crystal structures or is in the amorphous state without including the crystal structures; however, in the point that expansion and contraction due to heat are more isotropic, it is preferable that the mixture layer 70 is in the amorphous state.

Further, as the manufacturing method of the mixture layer 70, the layer may be independently manufactured; however, from the viewpoint of production efficiency, it is desirable that the mixture layer 70 be secondarily generated in the process of manufacturing the solid electrolyte layer 30 and the positive electrode layer 40.

### [Operation of Lithium-Ion Rechargeable Battery]

When the lithium-ion rechargeable battery 1 of the exemplary embodiment is to be charged, a negative electrode of a DC power supply is connected to the substrate 10 that functions as the negative electrode collector layer, and a positive electrode of the DC power supply is connected to the positive electrode collector layer 50. Then, the lithium ions constituting the positive-electrode active material in the positive electrode layer 40 are moved to the negative electrode layer 20 through the solid electrolyte layer 30 and are contained in the negative-electrode active material in the negative electrode layer 20.

Moreover, when the charged lithium-ion rechargeable battery 1 is to be used (discharged), a negative electrode of a DC load is connected to the substrate 10 that functions as the negative electrode collector layer, and a positive electrode of the DC load is connected to the positive electrode collector layer 50. Then, the lithium-ion contained in the negative-electrode active material in the negative electrode layer 20 are moved to the positive electrode layer 40 through the solid electrolyte layer 30, to thereby constitute the positive-electrode active material in the positive electrode layer 40.

Here, in the lithium-ion rechargeable battery 1 of the exemplary embodiment, as shown in FIGS. 1 and 2, the negative electrode layer 20 and the solid electrolyte layer 30 are disposed with the entire peripheries thereof being aligned, and the entire periphery of the positive electrode layer 40 is disposed inside the entire periphery of the solid electrolyte layer 30. Consequently, in the lithium-ion rechargeable battery 1, there is provided a structure in which the negative electrode layer 20 and the positive electrode layer 40 are less likely to directly contact each other without the solid electrolyte layer 30, to thereby suppress the leakage within the lithium-ion rechargeable battery 1.

### [Method for Producing Lithium-Ion Rechargeable Battery]

Next, the method for producing (method for manufacturing) the lithium-ion rechargeable battery 1 shown in FIG. 1 will be described.

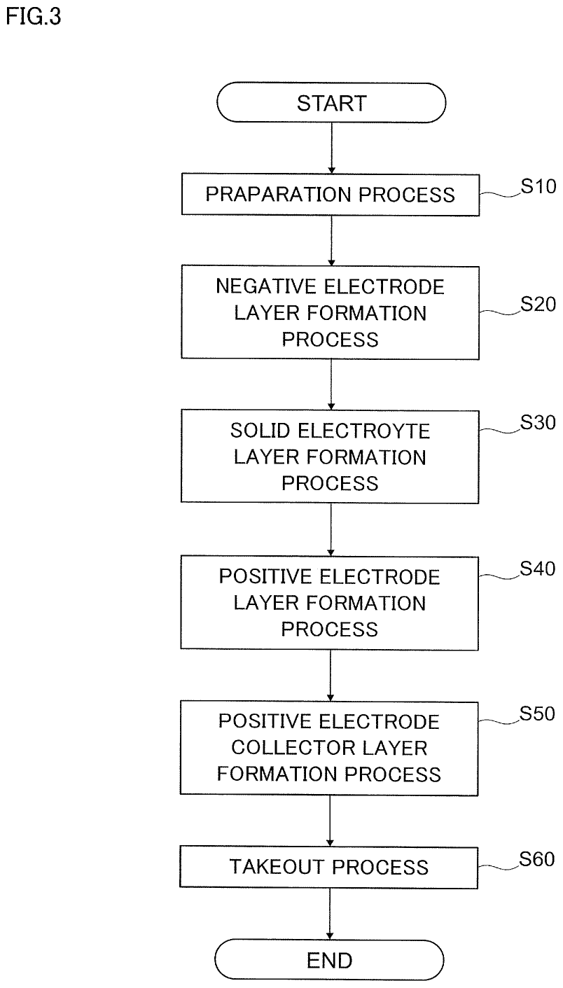

FIG. 3 is a flowchart for illustrating the method for producing the lithium-ion rechargeable battery 1.

Prior to producing the lithium-ion rechargeable battery 1, the substrate 10 is prepared and a preparation process that mounts the substrate 10 onto a not-shown sputtering device is performed (step 10).

Next, in the above-described sputtering device, a negative electrode layer formation process that forms the negative electrode layer 20 on the substrate 10 is performed (step 20).

Subsequently, in the above-described sputtering device, a solid electrolyte layer formation process that forms the solid electrolyte layer 30 on the negative electrode layer 20 is performed (step 30).

Next, in the above-described sputtering device, a positive electrode layer formation process that forms the positive electrode layer 40 on the solid electrolyte layer 30 is performed (step 40). Here, in the exemplary embodiment, in the positive electrode layer formation process of the step 40, in addition to forming the positive electrode layer 40, the intermediate layer 60 and the mixture layer 70 are formed inside the solid electrolyte layer 30.

In the positive electrode layer formation process of step 40, to form the intermediate layer 60 and the mixture layer 70 inside the solid electrolyte layer 30, it is preferable to set the formation rate of the positive electrode layer 40 at 0.5 nm/second to 50 nm/second, more preferably, 1 nm/second to 10 nm/second. With the above formation rate, it is possible to set the thicknesses of the intermediate layer 60 and the mixture layer 70 in an appropriate range.

Thereafter, in the above-described sputtering device, a positive electrode collector layer formation process that forms the positive electrode collector layer 50 on the positive electrode layer 40 is performed (step 50).

Then, a takeout process that takes out the lithium-ion rechargeable battery 1, which is formed by laminating, on the substrate 10, the negative electrode layer 20, the solid electrolyte layer 30, the positive electrode layer 40 and the positive electrode collector layer 50, and further includes the intermediate layer 60 and the mixture layer 70, from the sputtering device is performed (step 60).

### [Others]

In the exemplary embodiment, the configuration in which the negative electrode layer 20, the solid electrolyte layer 30 and the positive electrode layer 40 are laminated on the substrate 10 in this order is adopted; however, the present invention is not limited thereto. In other words, if at least the mixture layer 70 is formed at the boundary portion of the solid electrolyte layer 30 and the positive electrode layer 40, a configuration in which, on the substrate 10, the positive electrode layer 40, the solid electrolyte layer 30 and the negative electrode layer 20 are laminated in this order, may be adopted. Moreover, in this case, a negative electrode collector layer made of a solid thin film having electron conductivity may be provided on the negative electrode layer 20.

### EXAMPLE

Hereinafter, the present invention will be described in further detail based on Example. However, the present invention is not limited to the following Example unless the gist is exceeded.

The present inventors produced two types of lithium-ion rechargeable batteries, and made evaluation about the cross-sectional structure and the discharge capacity of each battery.

In Example, the lithium-ion rechargeable battery 1 having the lamination structure described in the above-described exemplary embodiment (refer to FIG. 1) was used. In contrast thereto, in Comparative Example, a lithium-ion rechargeable battery 2 to be described below was used.

### [Configuration of Lithium-Ion Rechargeable Battery in Comparative Example]

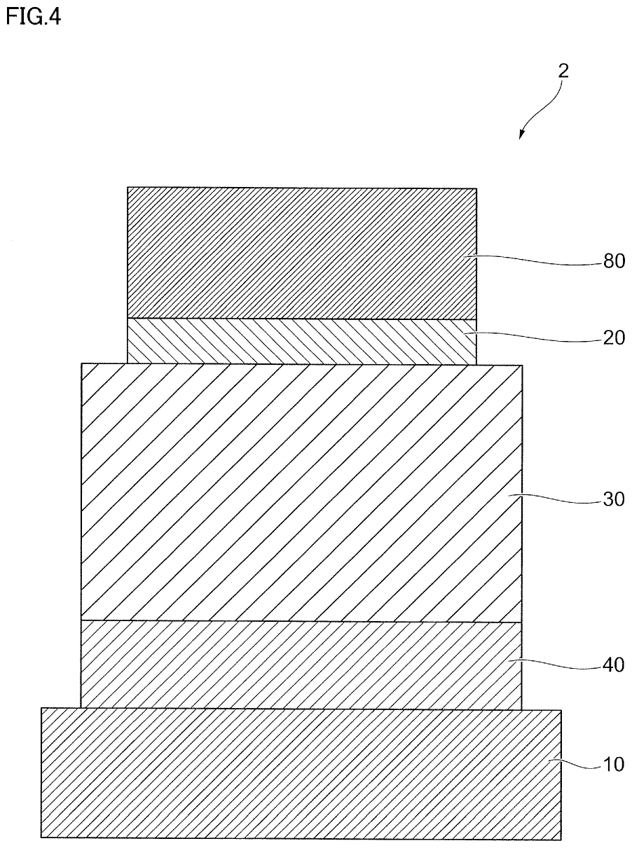

FIG. 4 is a diagram showing a cross-sectional configuration of the lithium-ion rechargeable battery 2 in Comparative Example.

The lithium-ion rechargeable battery 2 includes: a substrate 10; a positive electrode layer 40 laminated on the substrate 10; a solid electrolyte layer 30 laminated on the positive electrode layer 40; a negative electrode layer 20 laminated on the solid electrolyte layer 30; and a negative electrode collector layer 80 laminated on the negative electrode layer 20.

As described above, the lithium-ion rechargeable battery 2 in Comparative Example is different from the lithium-ion rechargeable battery 1 in Example shown in FIG. 1 in the point that the positions of the negative electrode layer 20 and the positive electrode layer 40 are exchanged. Moreover, the lithium-ion rechargeable battery 2 in Comparative Example is different from the lithium-ion rechargeable battery 1 in Example in the point that the negative electrode collector layer 80 is provided in place of the positive electrode collector layer 50. Further, the lithium-ion rechargeable battery 2 in Comparative Example is different from the lithium-ion rechargeable battery 1 in Example in the point that there are no intermediate layer 60 and mixture layer 70 between the solid electrolyte layer 30 and the positive electrode layer 40.

Here, as the substrate 10, the negative electrode layer 20, the solid electrolyte layer 30 and the positive electrode layer 40, the ones same as those described in the exemplary embodiment can be used. Moreover, as the negative electrode collector layer 80, the one same as that described in the positive electrode collector layer 50 in the exemplary embodiment can be used.

### [Method for Producing Lithium-Ion Rechargeable Battery in Example]

Now, the method for producing the lithium-ion rechargeable battery 1 in Example will be described.

Here, Table 1 shows production conditions of the lithium-ion rechargeable battery 1 in Example. To described more specifically, Table 1 shows the relationship between the name of each component of the lithium-ion rechargeable battery 1 in Example and the configuration (the material, size, thickness and structure) of each component. However, since the intermediate layer 60 and the mixture layer 70 provided to the lithium-ion rechargeable battery 1 of Example are secondarily generated in laminating the positive electrode layer 40 on the solid electrolyte layer 30, description thereof is omitted here.

TABLE 1

| Example | | Configuration | | | |
|---|---|---|---|---|---|
| Component Name | Material | Size | Thickness | | Structure |
| Substrate | SUS304 | 50 mm × 50 mm | 30 | μm | Crystal |
| Negative Electrode | Si(B) | 10 mm × 10 mm | 200 | nm | Amorphous |
| Layer | (Target) | | | | |
| Solid Electrolyte | LiPON | 10 mm × 10 mm | 600 | nm | Amorphous |
| Layer | (Target) | | | | |
| Positive Electrode | Li_{1.5}Mn₂O₄ | 8 mm × 8 mm | 100 | nm | Amorphous |
| Layer | (Target) | | | | |
| Positive Electrode | Ti | 8 mm × 8 mm | 300 | nm | Crystal |
| Collector Layer | (Target) | | | | |

Now, with reference to FIG. 1 and Table 1, the method for producing the lithium-ion rechargeable battery 1 in Example will be described.

In Example, SUS304 was used as the substrate 10. The size of the substrate 10 was set at 50 mm×50 mm, and the thickness thereof was set at 30 μm.

In Example, the negative electrode layer 20 was formed by using the sputtering method. In forming the negative electrode layer 20, as the sputtering target, silicon (Si) doped with boron (B) was used. Note that, in Table 1, the material was represented as “Si(B).”

In the negative electrode layer formation process, deposition was performed by the DC sputtering method. At this time, the atmosphere in the chamber was Ar, the gas pressure in the chamber was 0.8 Pa, and the sputtering power was 500 W. Then, a mask was disposed to cause the size of the negative electrode layer 20 to be 10 mm×10 mm, and the deposition time was set so that the thickness thereof became 200 nm.

Further, in Example, the solid electrolyte layer 30 was formed by using the sputtering method. In forming the solid electrolyte layer 30, as the sputtering target, LiPON (LiₐPO_{b}N_{c}), which was obtained by replacing a part of oxygen in Li₃PO₄ with nitrogen, was used.

In the solid electrolyte layer formation process, deposition was performed by the AC sputtering method. At this time, the atmosphere in the chamber was N₂, the gas pressure in the chamber was 0.5 Pa, and the sputtering power was 500 W. Then, a mask was disposed to cause the size of the solid electrolyte layer 30 to be 10 mm×10 mm, and the deposition time was set so that the thickness thereof became 600 nm.

Still further, in Example, the positive electrode layer 40 was formed by using the sputtering method. In forming the positive electrode layer 40, as the sputtering target, Li_{1.5}Mn₂O₄ containing Li, Mn and O was used. Note that, different from LiMn₂O₄ and Li₂Mn₂O₄ widely used as the positive-electrode active material, Li_{1.5}Mn₂O₄ does not satisfy a stoichiometric composition.

In the positive electrode layer formation process, deposition was performed by the DC sputtering method. At this time, the atmosphere in the chamber was Ar/O₂, the gas pressure in the chamber was 0.5 Pa, and the sputtering power was 500 W. Then, a mask was disposed to cause the size of the positive electrode layer 40 to be 8 mm×8 mm, and the deposition time was set so that the thickness thereof became 100 nm. Note that, in Example, the intermediate layer 60 and the mixture layer 70 are also formed during this time; however, details thereof will be described later.

Then, in Example, the positive electrode collector layer 50 was formed by using the sputtering method. In forming the positive electrode collector layer 50, as the sputtering target, titanium (Ti) was used.

In the positive electrode collector layer formation process, deposition was performed by the DC sputtering method. At this time, the atmosphere in the chamber was Ar, the gas pressure in the chamber was 0.8 Pa, and the sputtering power was 500 W. Then, a mask was disposed to cause the size of the positive electrode collector layer 50 to be 8 mm×8 mm, and the deposition time was set so that the thickness thereof became 300 nm.

On the lithium-ion rechargeable battery 1 of Example thus obtained, an analysis by the X-ray diffraction (XRD) was performed. As a result, the substrate 10 and the positive electrode collector layer 50 were crystallized. In contrast thereto, the negative electrode layer 20, the solid electrolyte layer 30 and the positive electrode layer 40 were amorphized. Moreover, the intermediate layer 60 and the mixture layer 70 existing between the solid electrolyte layer 30 and the positive electrode layer 40 were also amorphized.

### [Method for Producing Lithium-Ion Rechargeable Battery in Comparative Example]

Next, the method for producing the lithium-ion rechargeable battery 1 in Comparative Example will be described.

Here, Table 2 shows production conditions of the lithium-ion rechargeable battery 2 in Comparative Example. To described more specifically, Table 2 shows the relationship between the name of each component constituting the lithium-ion rechargeable battery 2 in Comparative Example and the configuration (the material, size, thickness and structure) of each component.

TABLE 2

| Comparative Example | | Configuration | | | |
|---|---|---|---|---|---|
| Component Name | Material | Size | Thickness | | Structure |
| Substrate | SUS304 | 50 mm × 50 mm | 30 | μm | Crystal |
| Positive Electrode | Li_{1.5}Mn₂O₄ | 10 mm × 10 mm | 100 | nm | Amorphous |
| Layer | (Target) | | | | |
| Solid Electrolyte | LiPON | 10 mm × 10 mm | 600 | nm | Amorphous |
| Layer | (Target) | | | | |
| Negative Electrode | Si(B) | 8 mm × 8 mm | 200 | nm | Amorphous |
| Layer | (Target) | | | | |
| Negative Electrode | Ti | 8 mm × 8 mm | 300 | nm | Crystal |
| Collector Layer | (Target) | | | | |

Now, with reference to FIG. 4 and Table 2, the method for producing the lithium-ion rechargeable battery 2 in Comparative Example will be described.

In Comparative Example, also, SUS304 was used as the substrate 10. Here, the size (50 mm×50 mm) and the thickness (30 μm) of the substrate 10 were set at the same as those of Example.

In Comparative Example, by using the sputtering method, the positive electrode layer 40, the solid electrolyte layer 30 and the negative electrode layer 20 were formed in this order. Here, the production conditions of each of the positive electrode layer 40, the solid electrolyte layer 30 and the negative electrode layer 20 were basically the same as those of Example.

Moreover, in Comparative Example, the negative electrode collector layer 80 was formed by using the sputtering method. Note that the production conditions of the negative electrode collector layer 80 were basically the same as those of the positive electrode collector layer 50 in Example.

However, in production of the lithium-ion rechargeable battery 2 in Comparative Example, the size of the positive electrode layer 40 and the solid electrolyte layer 30 was 10 mm×10 mm, and the size of the negative electrode layer 20 and the negative electrode collector layer 80 was 8 mm×8 mm.

On the lithium-ion rechargeable battery 2 of Comparative Example thus obtained, an analysis by the X-ray diffraction (XRD) was performed. As a result, the substrate 10 and the negative electrode collector layer 80 were crystallized. In contrast thereto, the positive electrode layer 40, the solid electrolyte layer 30 and the negative electrode layer 20 were amorphized.

### [Evaluation of Lithium-Ion Rechargeable Battery]

Here, as the criteria for evaluating the lithium-ion rechargeable battery 1 in Example and the lithium-ion rechargeable battery 2 in Comparative Example, the cross-sectional structure and the charge-discharge characteristics of both batteries were used.

### (Cross-Sectional Configuration)

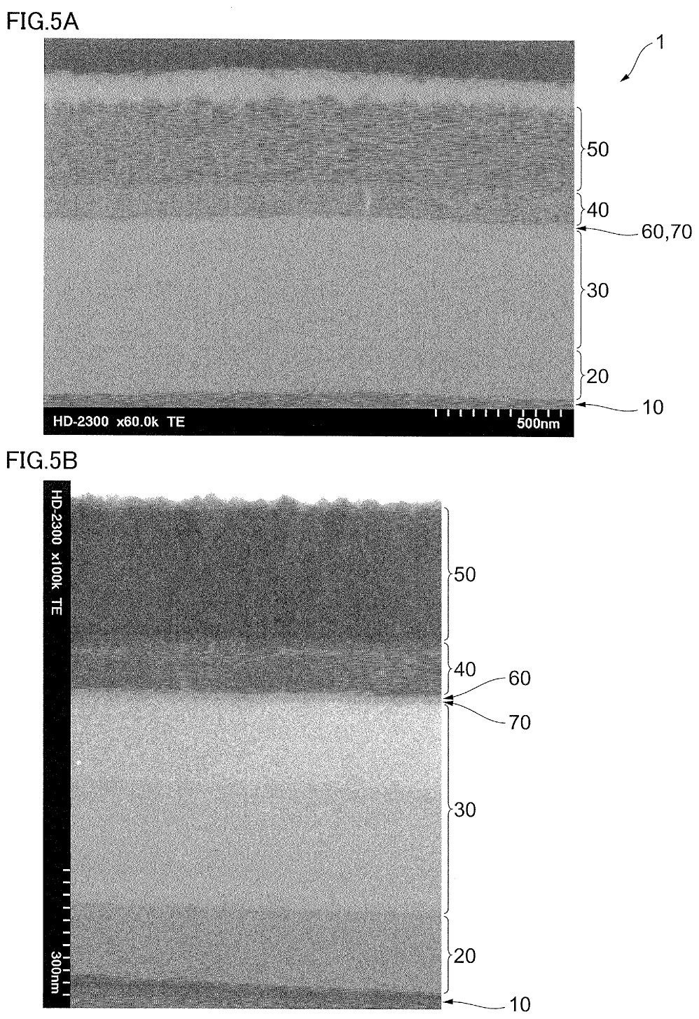

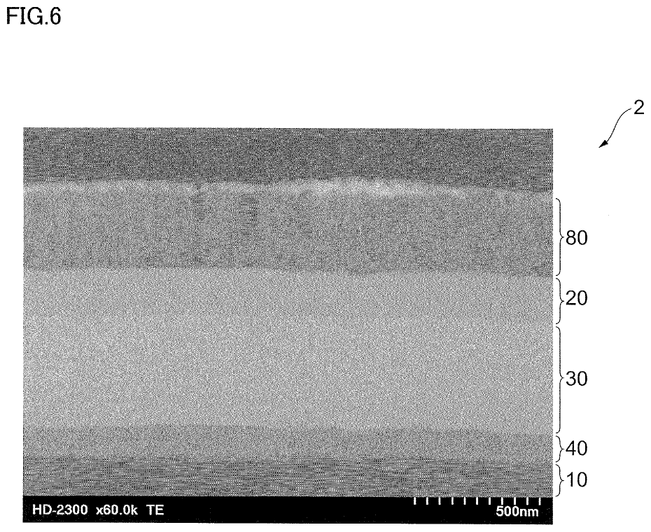

FIG. 5 shows the cross-sectional STEM (scanning transmission electron microscope) photographs of the lithium-ion rechargeable battery 1 in Example. FIG. 6 is a cross-sectional STEM photograph of the lithium-ion rechargeable battery 2 in Comparative Example. Here, the magnification in FIG. 5A is 60-thousand folds, and the magnification in FIG. 5B is 100-thousand folds. Moreover, the magnification in FIG. 6 is 60-thousand folds, which is the same as FIG. 5A.

These STEM photographs were taken by use of Ultra-thin Film Evaluation System HD-2300 manufactured by Hitachi High-Technologies Corporation. Here, STEM has characteristics capable of obtaining an image reflecting composition information. To describe more specifically, in the STEM, a region where heavy elements exist is expressed as relatively blackish, and a region where light elements exist is expressed as relatively whitish. Note that, since lithium is a light element next to hydrogen and helium, the regions where lithium exists in the STEM photographs shown in FIGS. 5 and 6 are expressed as whitish. Here, the reason why the region positioned at the uppermost in each of FIG. 5A and FIG. 6 is black is that W (tungsten) attached to each sample in taking the STEM photograph is seen.

First, with reference to FIG. 5, description will be given of the cross-sectional structure of the lithium-ion rechargeable battery 1 in Example.

The lithium-ion rechargeable battery 1 shown in FIG. 5A has a cross-sectional structure in which the substrate 10, the negative electrode layer 20, the solid electrolyte layer 30, the positive electrode layer 40 and the positive electrode collector layer 50 are laminated in this order. However, it can be seen that, at the boundary portion of the solid electrolyte layer 30 and the positive electrode layer 40, there exists a layer with a concentration different from those of the solid electrolyte layer 30 and the positive electrode layer 40. Here, with reference to the enlarged photograph in FIG. 5B, the layer existing between the solid electrolyte layer 30 and the positive electrode layer 40 can be divided into a layer positioned closer to the positive electrode layer 40 with uniform concentration and a layer positioned closer to the solid electrolyte layer 30 with non-uniform (uneven) concentration. Of these, the layer with uniform concentration is the intermediate layer 60, and the layer with non-uniform concentration is the mixture layer 70. From FIG. 5B, it can be understood that the intermediate layer 60 has the concentration intermediate between the solid electrolyte layer 30 and the positive electrode layer 40. Moreover, it can be understood that the mixture layer 70 contains the base material having the same concentration as that of the solid electrolyte layer 30 and particles having the same concentration as those of the positive electrode layer 40 and dispersed into the base material.

However, in the intermediate layer 60, there also exist the particles having the same concentration as those of the positive electrode layer 40. Note that, from the STEM photograph shown in FIG. 5B, the thickness of the intermediate layer 60 was about 30 nm. Moreover, the thickness of the mixture layer 70 was about 50 nm.

Next, by use of the above-described Ultra-thin Film Evaluation System HD-2300 manufactured by Hitachi High-Technologies Corporation, evaluation by elemental mapping was performed on the region where the STEM photograph shown in FIG. 5A was taken. Here, seven elements of carbon (C), titanium (Ti), silicon (Si), phosphorous (P), nitrogen (N), oxygen (O) and manganese (Mn) were analyzed.

The elemental mapping performed on carbon (C) showed that the relative concentration thereof was increased in the substrate 10, whereas the relative concentration thereof was reduced in others. This results from carbon contained in SUS304 constituting the substrate 10.

The elemental mapping performed on titanium (Ti) showed that the relative concentration thereof was increased in the positive electrode collector layer 50, whereas the relative concentration thereof was reduced in others. This results from titanium constituting the positive electrode collector layer 50.

The elemental mapping performed on silicon (Si) showed that the relative concentration thereof was increased in the negative electrode layer 20, whereas the relative concentration thereof was reduced in others. This results from silicon constituting the positive electrode layer 20 as a main component.

The elemental mapping performed on phosphorous (P) showed that the relative concentration thereof was increased in the solid electrolyte layer 30, the intermediate layer 60 and the mixture layer 70, whereas the relative concentration thereof was reduced in others. This results from phosphorous contained in LiPON constituting the solid electrolyte layer 30. Moreover, the result turned out that both the intermediate layer 60 and the mixture layer 70 contained phosphorous.

The elemental mapping performed on nitrogen (N) showed that the relative concentration thereof was increased in the solid electrolyte layer 30, the intermediate layer 60 and the mixture layer 70, whereas the relative concentration thereof was reduced in others. This results from nitrogen contained in LiPON constituting the solid electrolyte layer 30. Moreover, the result turned out that both the intermediate layer 60 and the mixture layer 70 contained nitrogen.

The elemental mapping performed on oxygen (O) showed that the relative concentration thereof was increased in the solid electrolyte layer 30, the positive electrode layer 40, the intermediate layer 60 and the mixture layer 70, whereas the relative concentration thereof was reduced in others. This results from oxygen contained in LiPON constituting the solid electrolyte layer 30 and in Li_{1.5}Mn₂O₄ constituting the positive electrode layer 40. Moreover, the result turned out that both the intermediate layer 60 and the mixture layer 70 contained oxygen.

The elemental mapping performed on manganese (Mn) showed that the relative concentration thereof was increased in the positive electrode layer 40, the intermediate layer 60 and the mixture layer 70, whereas the relative concentration thereof was reduced in others. This results from manganese contained in Li_{1.5}Mn₂O₄ constituting the positive electrode layer 40. Moreover, the result turned out that both the intermediate layer 60 and the mixture layer 70 contained manganese.

From the above results of the elemental mapping, it was turned out that the intermediate layer 60 and the mixture layer 70 contained the constituent materials of the solid electrolyte layer 30 (lithium, phosphorous, oxygen and nitrogen) and the constituent materials of the positive electrode layer 40 (lithium, manganese and oxygen).

Then, in the STEM photographs shown in FIG. 5, it is suggested that, in the intermediate layer 60 having the uniform concentration, these lithium, phosphorous, oxygen and nitrogen exist in the state of forming a compound. Moreover, in the STEM photographs shown in FIG. 5, it is suggested that, in the mixture layer 70 having the non-uniform concentration, the fillers composed of Li_{1.5}Mn₂O₄ exist in the state of being dispersed into the matrix composed of LiPON.

Moreover, analysis of valence of manganese (Mn) in the positive electrode layer 40 of the lithium-ion rechargeable battery 1 in Example by EELS (Electron Energy Loss Spectroscopy) showed that it was divalent.

Subsequently, with reference to FIG. 6, description will be given of the cross-sectional structure of the lithium-ion rechargeable battery 2 in Comparative Example.

The lithium-ion rechargeable battery 2 shown in FIG. 6 has a cross-sectional structure in which the substrate 10, the positive electrode layer 40, the solid electrolyte layer 30, the negative electrode layer 20 and the negative electrode collector layer 80 are laminated in this order. However, at the boundary portion of the positive electrode layer 40 and the solid electrolyte layer 30 in the lithium-ion rechargeable battery 2, neither the intermediate layer 60 nor the mixture layer 70 exists, which are shown in the lithium-ion rechargeable battery 1 in Example.

Next, by use of the above-described Ultra-thin Film Evaluation System HD-2300 manufactured by Hitachi High-Technologies Corporation, evaluation by elemental mapping was performed on the region where the STEM photograph shown in FIG. 6 was taken. Here, same as the above Example, seven elements of carbon (C), titanium (Ti), silicon (Si), phosphorous (P), nitrogen (N), oxygen (O) and manganese (Mn) were analyzed.

Except that the intermediate layer 60 and the mixture layer 70 were absent, the results similar to those in Example were obtained for each of carbon (C), titanium (Ti), silicon (Si), phosphorous (P), nitrogen (N), oxygen (O) and manganese (Mn).

Moreover, analysis of valence of manganese (Mn) in the positive electrode layer 40 of the lithium-ion rechargeable battery 2 in Comparative Example by EELS showed that it was divalent, which was the same as the lithium-ion rechargeable battery 1 in Example.

The reason why the intermediate layer 60 and the mixture layer 70 are not formed in the lithium-ion rechargeable battery 2 in Comparative Example, whereas they are formed in the lithium-ion rechargeable battery 1 in Example, is estimated as follows.

In Example and Comparative Example, while LiPON is used as the inorganic solid electrolyte constituting the solid electrolyte layer 30, Li_{1.5}Mn₂O₄ is used as the positive-electrode active material constituting the positive electrode layer 40. Then, manganese (Mn), which is the heaviest element among the elements constituting Li_{1.5}Mn₂O₄, is heavier than phosphorous (P), which is the heaviest element among the elements constituting LiPON.

In Example, the positive electrode layer 40 is formed on the solid electrolyte layer 30 by using the sputtering method. Therefore, when the solid electrolyte layer 30 that has already been laminated is bombarded with each element constituting the positive-electrode active material, the positive-electrode active material containing manganese is likely to enter the solid electrolyte layer 30. It is considered that, as a result, the intermediate layer 60 and the mixture layer 70 are formed between the solid electrolyte layer 30 and the positive electrode layer 40.

In contrast thereto, in Comparative Example, the solid electrolyte layer 30 is formed on the positive electrode layer 40 by using the sputtering method. Therefore, when the positive electrode layer 40 that has already been laminated is bombarded with each element constituting the inorganic solid electrolyte, the inorganic solid electrolyte containing phosphorous is less likely to enter the positive electrode layer 40. It is considered that, as a result, the intermediate layer 60 and the mixture layer 70 are less likely to be formed between the solid electrolyte layer 30 and the positive electrode layer 40.

### (Charge-Discharge Characteristics)

The charge-discharge characteristics were measured for each of the lithium-ion rechargeable battery 1 in Example and the lithium-ion rechargeable battery 2 in Comparative Example. As a measuring device of the charge-discharge characteristics, Battery Charge/Discharge System HJ1020mSD8 manufactured by HOKUTO DENKO CORPORATION was used. Here, the current in charging (charge current) and the current in discharging (discharge current) were 10 μA, 20 μA and 40 μA in each.

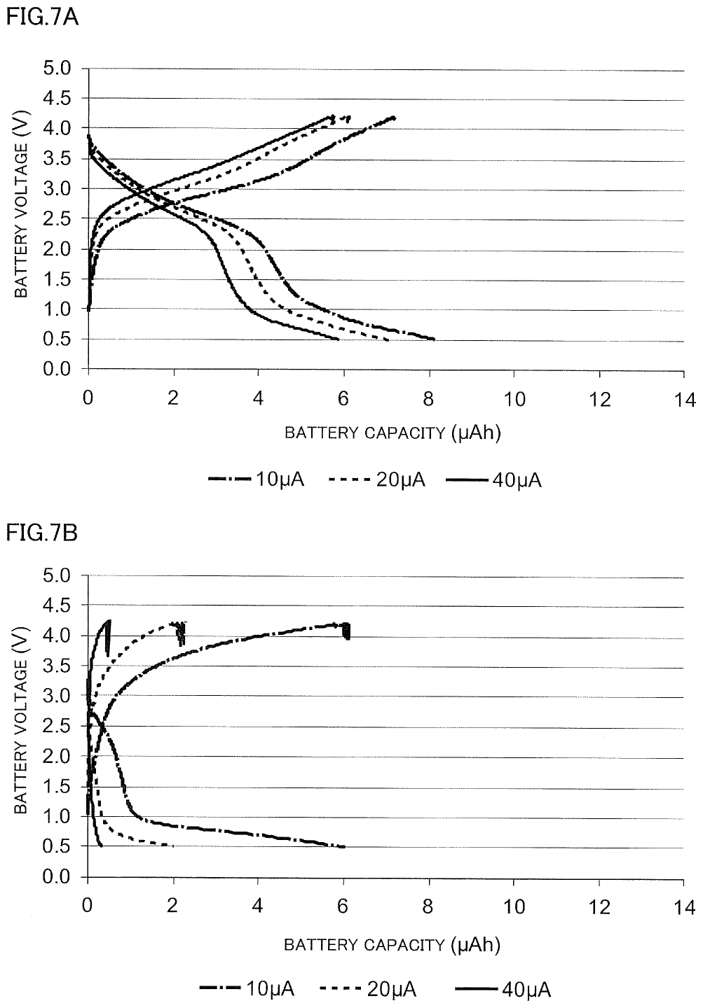

FIG. 7A is a diagram showing the charge-discharge characteristics of the lithium-ion rechargeable battery 1 in Example. Moreover, FIG. 7B is a diagram showing the charge-discharge characteristics of the lithium-ion rechargeable battery 2 in Comparative Example. Here, in each of FIGS. 7A and 7B, the horizontal axis indicates the battery capacity (μAh), and the vertical axis indicates the battery voltage (V). Moreover, in each of FIGS. 7A and 7B, a positively sloped curve in the figure indicates the charge characteristics, and a negatively sloped curve in the figure indicates the discharge characteristics.

In the lithium-ion rechargeable battery 1 in Example and the lithium-ion rechargeable battery 2 in Comparative Example, the negative electrode layer 20, the solid electrolyte layer 30 and the positive electrode layer 40 are configured with the same material and have the same thickness. However, as is clear from FIGS. 7A and 7B, in the lithium-ion rechargeable battery 2 in Comparative Example, the battery voltage sharply increases as compared to that in the lithium-ion rechargeable battery 1 in Example. As a result, in the lithium-ion rechargeable battery 2 in Comparative Example, the battery capacity at the completion of charging is smaller than that in the lithium-ion rechargeable battery 1 in Example. Moreover, in the lithium-ion rechargeable battery 2 in Comparative Example, the battery voltage sharply decreases in discharging as compared to that in the lithium-ion rechargeable battery 1 in Example. As described above, in the lithium-ion rechargeable battery 1 in Example, the battery capacity, in other words, the charge capacity and discharge capacity are increased as compared to those in the lithium-ion rechargeable battery 2 in Comparative Example.

It can be considered that the aforementioned difference results from the internal resistance of the lithium-ion rechargeable battery 1 in Example, which is lower than that of the lithium-ion rechargeable battery 2 in Comparative Example. Then, it can be considered that, in the lithium-ion rechargeable battery 1 in Example, since the mixture layer 70 and the like are provided at the boundary portion of the solid electrolyte layer 30 and the positive electrode layer 40, the internal resistance is reduced as compared to the lithium-ion rechargeable battery 2 in Comparative Example that does not include the mixture layer 70 and the like.

### REFERENCE SIGNS LIST

1, 2 Lithium-ion rechargeable battery

10 Substrate

20 Negative electrode layer

30 Solid electrolyte layer

40 Positive electrode layer

50 Positive electrode collector layer

60 Intermediate layer

70 Mixture layer

80 Negative electrode collector layer

1-8. (canceled)

9. A lithium-ion rechargeable battery comprising:
a positive electrode layer containing a positive-electrode active material;
a negative electrode layer containing a negative-electrode active material;
a solid electrolyte layer containing an inorganic solid electrolyte having lithium-ion conductivity, the solid electrolyte layer being provided between the positive electrode layer and the negative electrode layer; and
a mixture layer containing a mixture of the positive-electrode active material and the inorganic solid electrolyte, the mixture layer being provided between the positive electrode layer and the solid electrolyte layer.

10. The lithium-ion rechargeable battery according to claim 9, wherein the positive-electrode active material contains an element heavier than an element contained in the inorganic solid electrolyte.

11. The lithium-ion rechargeable battery according to claim 9, wherein, in the mixture layer, particles composed of the positive-electrode active material are dispersed into a base material composed of the inorganic solid electrolyte.

12. The lithium-ion rechargeable battery according to claim 10, wherein, in the mixture layer, particles composed of the positive-electrode active material are dispersed into a base material composed of the inorganic solid electrolyte.

13. The lithium-ion rechargeable battery according to claim 9, wherein a boundary portion of the positive electrode layer and the mixture layer is provided with an intermediate layer containing a constituent material of the positive-electrode active material and a constituent material of the inorganic solid electrolyte, and further containing the positive-electrode active material mixed therewith.

14. The lithium-ion rechargeable battery according to claim 10, wherein a boundary portion of the positive electrode layer and the mixture layer is provided with an intermediate layer containing a constituent material of the positive-electrode active material and a constituent material of the inorganic solid electrolyte, and further containing the positive-electrode active material mixed therewith.

15. The lithium-ion rechargeable battery according to claim 11, wherein a boundary portion of the positive electrode layer and the mixture layer is provided with an intermediate layer containing a constituent material of the positive-electrode active material and a constituent material of the inorganic solid electrolyte, and further containing the positive-electrode active material mixed therewith.

16. The lithium-ion rechargeable battery according to claim 12, wherein a boundary portion of the positive electrode layer and the mixture layer is provided with an intermediate layer containing a constituent material of the positive-electrode active material and a constituent material of the inorganic solid electrolyte, and further containing the positive-electrode active material mixed therewith.

17. The lithium-ion rechargeable battery according to claim 13, further comprising:
a substrate on which the negative electrode layer, the intermediate layer and the positive electrode layer are laminated in this order.

18. The lithium-ion rechargeable battery according to claim 14, further comprising:
a substrate on which the negative electrode layer, the intermediate layer and the positive electrode layer are laminated in this order.

19. The lithium-ion rechargeable battery according to claim 15, further comprising:
a substrate on which the negative electrode layer, the intermediate layer and the positive electrode layer are laminated in this order.

20. The lithium-ion rechargeable battery according to claim 16, further comprising:
a substrate on which the negative electrode layer, the intermediate layer and the positive electrode layer are laminated in this order.

21. A method for manufacturing a lithium-ion rechargeable battery, comprising:
a negative electrode layer formation process that forms a negative electrode layer containing a negative-electrode active material;
a solid electrolyte layer formation process that forms a solid electrolyte layer on the negative electrode layer, the solid electrolyte layer containing an inorganic solid electrolyte having lithium-ion conductivity; and
a positive electrode layer formation process that forms, on the solid electrolyte layer, a mixture layer containing a mixture of a positive-electrode active material and the inorganic solid electrolyte, and forms, on the mixture layer, a positive electrode layer containing the positive-electrode active material.

22. The method for manufacturing a lithium-ion rechargeable battery according to claim 21, wherein,
in the positive electrode layer formation process, the mixture layer and the positive electrode layer are formed by a sputtering method, and
the positive-electrode active material contains an element heavier than an element contained in the inorganic solid electrolyte.

23. The method for manufacturing a lithium-ion rechargeable battery according to claim 21, wherein, in the positive electrode layer formation process, on the mixture layer, an intermediate layer containing a constituent material of the positive-electrode active material and a constituent material of the inorganic solid electrolyte, and further containing the positive-electrode active material mixed therewith is further formed.

24. The method for manufacturing a lithium-ion rechargeable battery according to claim 22, wherein, in the positive electrode layer formation process, on the mixture layer, an intermediate layer containing a constituent material of the positive-electrode active material and a constituent material of the inorganic solid electrolyte, and further containing the positive-electrode active material mixed therewith is further formed.
